(19) United States
(12) Patent Application Publication
(10) Pub. No.: US 2019/0359407 A1
(43) Pub. Date: Nov. 28, 2019

(54) Packaged Meal Kit

(71) Applicant: Blue Apron, LLC, New York, NY (US)

(72) Inventors: Gaurav Nandkishor Kale, Edison, NJ (US); Gaurav Raut, New York, NY (US); Andrew Wai Hoong Boey, West New York, NJ (US)

(21) Appl. No.: 15/989,107

(22) Filed: May 24, 2018

(51) Int. Cl. B65D 77/04; A23L 3/36; A23B 4/06; B65D 5/42; B65D 5/49; B65D 5/46; B65D 5/60; B65D 81/38; F25D 3/00

(52) U.S. Cl. CPC B65D 77/0413; A23L 3/364; A23B 4/068; B65D 5/4233; B65D 5/48046; B65D 2577/045; B65D 5/60; B65D 81/3858; F25D 3/005; A23V 2002/00; B65D 5/46072

(57) ABSTRACT

A packaged meal kit includes a container, a liner, a first cold pack, a frozen food item, a protective insert, a non-frozen food item, a second cold pack, and instructions. The liner is disposed adjacent an interior of the container. The first cold pack is disposed in a bottom of the container adjacent the liner. The frozen food item is disposed above the first cold pack. The protective insert is disposed above the frozen food item. The protective insert includes a hollow cross-section. The non-frozen food item is disposed in the hollow cross-section. The second cold pack is disposed above the protective insert. Instructions are disposed in the container for preparing a meal including the frozen and non-frozen food items.

### BACKGROUND

### Field

The present disclosure relates to meal kit packaging. More specifically, embodiments of the present disclosure relate to a packaged meal kit.

### Background

Meal kit delivery services are a new and innovative means for food delivery and allow consumers greater variety, flexibility, and efficiency for preparing meals at home. Fresh ingredients as well as instructions for cooking them at home are provided in the delivered meal kit. Meal kit delivery services are a modern alternative to grocery shopping. Since 2012, online direct-to-door meal kit service market revenue has steadily increased, and is expected to eclipse $10 billion in 2020.

In warm climates or during warm seasons, shipping perishable food items runs the risk of spoilage and decay due to environmental conditions (e.g., temperature, humidity, etc.). During shipping, insulation and cooling are key to preserving perishable food items like seafood, meats, vegetables, fruits, and dairy. A shipping container with cold preserving packaging ideally maintains colder temperatures around frozen food items relative to non-frozen food items, and protects each from damage and temperature variations during shipping and handling. However, if the items are not well segregated, more perishable items like fresh vegetables can become damaged by frozen items or by cooling packaging placed in the container to keep the items sufficiently cold until the user empties the container and puts the items in a refrigerator or freezer. In addition, if cooling packaging is placed only in certain regions of the container the cooling of perishable food items may not be achieved throughout the meal kit.

### BRIEF SUMMARY

In some embodiments, a packaged meal kit includes a container, a liner, a first cold pack, a frozen food item, a protective insert, a non-frozen food item, a second cold pack, and instructions. In some embodiments, the liner is disposed adjacent an interior of the container. In some embodiments, the first cold pack is disposed in a bottom of the container adjacent the liner. In some embodiments, the frozen food item is disposed above the first cold pack. In some embodiments, the protective insert is disposed above the frozen food item. In some embodiments, the protective insert is configured to provide a protective space within an interior of the protective insert. In some embodiments, the protective insert includes a hollow cross-section. In some embodiments, the hollow cross-section extends along an axis parallel to a front surface of the container. In some embodiments, the non-frozen food item is disposed in the hollow cross-section. In some embodiments, the non-frozen food item is disposed in the protective space created by the protective insert. In some embodiments, the second cold pack is disposed above the protective insert. In some embodiments, instructions are disposed in the container for preparing a meal including the frozen food item and the non-frozen food item. In some embodiments, the frozen food item and the non-frozen food item are pre-portioned. In some embodiments, the frozen food item and the non-frozen food item are pre-portioned to prepare the meal based on the instructions. In some embodiments, the liner is a sealable thermally insulating liner. In some embodiments, the liner encloses the first cold pack, the frozen food item, the protective insert, the non-frozen food item, and the second cold pack.

In some embodiments, the container is a cardboard cuboid. In some embodiments, the frozen food item is a protein. In some embodiments, the frozen food item is a meat or seafood. In some embodiments, the non-frozen food item is a non-protein. In some embodiments, the non-frozen food item is not a meat or seafood. In some embodiments, the protective insert is a unitary foldable cardboard sleeve. In some embodiments, a first distal end and a second distal end of the unitary foldable cardboard sleeve are fastened together to create the hollow cross-section. In some embodiments, the first and second distal ends are fastened by a tab and a slot. In some embodiments, the frozen and non-frozen food items are pre-portioned to correspond to portions identified on the instructions. In some embodiments, the instructions are provided on a card. In some embodiments, the instructions are provided on the protective insert. In some embodiments, the protective insert includes a handle. In some embodiments, the packaged meal kit further includes a third cold pack disposed above the frozen food item and below the protective insert. In some embodiments, the liner encloses the first cold pack, the frozen food item, the third cold pack, the protective insert, the non-frozen food item, and the second cold pack.

In some embodiments, a packaged meal kit includes a container, a cold pack, a frozen food item, a protective insert, a non-frozen food item, and instructions. In some embodiments, the cold pack is disposed in a bottom of the container. In some embodiments, the frozen food item is disposed above the cold pack. In some embodiments, the protective insert is disposed above the frozen food item. In some embodiments, the protective insert is configured to provide a protective space within an interior of the protective insert. In some embodiments, the protective insert includes a hollow cross-section. In some embodiments, a non-frozen food item is disposed in the hollow cross-section. In some embodiments, instructions are disposed in the container for preparing a meal including the frozen food item and the non-frozen food item.

In some embodiments, the packaged meal kit further includes a thermally insulating liner disposed adjacent an interior of the container. In some embodiments, the frozen food item is a protein. In some embodiments, the frozen food item is a meat or seafood. In some embodiments, the protective insert is a unitary foldable cardboard sleeve. In some embodiments, the protective insert includes a bottom surface. In some embodiments, the packaged meal kit further includes a second cold pack disposed above the protective insert. In some embodiments, the instructions are provided on a card. In some embodiments, the instructions are provided on the protective insert.

In some embodiments, a packaged meal kit includes a container, a liner, a protective insert, a non-frozen food item, a first cold pack, a frozen food item, a second cold pack, and instructions. In some embodiments, the liner is disposed adjacent an interior of the container. In some embodiments, the first protective insert is disposed in a bottom of the container adjacent the liner. In some embodiments, the protective insert is configured to provide a protective space within an interior of the protective insert. In some embodiments, the protective insert includes a hollow cross-section. In some embodiments, the hollow cross-section extends along an axis parallel to a front surface of the container. In some embodiments, the non-frozen food item is disposed in the hollow cross-section. In some embodiments, the first cold pack is disposed above the protective insert. In some embodiments, a frozen food item is disposed above the first cold pack. In some embodiments, the second cold pack is disposed above the frozen food item. In some embodiments, instructions are disposed in the container for preparing a meal including the frozen food item and the non-frozen food item. In some embodiments, the frozen food item and the non-frozen food item are pre-portioned. In some embodiments, the frozen food item and the non-frozen food item are pre-portioned to prepare the meal based on the instructions. In some embodiments, the protective insert includes a handle. In some embodiments, the liner is a sealable thermally insulating liner with a first opening and a second opening opposite the first opening.

In some embodiments, a packaged meal kit includes a container, a liner, a first cold pack, a protective insert, a non-frozen food item, a second cold pack, and instructions. In some embodiments, the liner is disposed adjacent an interior of the container. In some embodiments, the first cold pack is disposed in a bottom of the container adjacent the liner. In some embodiments, the protective insert is disposed above the first cold pack. In some embodiments, the protective insert is configured to provide a protective space within an interior of the protective insert. In some embodiments, the protective insert includes a hollow cross-section. In some embodiments, the hollow cross-section extends along an axis parallel to a front surface of the container. In some embodiments, the non-frozen food item is disposed in the hollow cross-section. In some embodiments, the non-frozen food item is disposed in the protective space created by the protective insert. In some embodiments, the second cold pack is disposed above the protective insert. In some embodiments, instructions are disposed in the container for preparing a meal including the non-frozen food item. In some embodiments, the non-frozen food item is pre-portioned. In some embodiments, the non-frozen food item is pre-portioned to prepare the meal based on the instructions. In some embodiments, the liner is a sealable thermally insulating liner. In some embodiments, the liner encloses the first cold pack, the protective insert, the non-frozen food item, and the second cold pack. In some embodiments, the non-frozen food item is not a meat or seafood.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a cross-sectional view of a packaged meal kit, according to an embodiment.

FIG. 2 illustrates a perspective exploded view of the packaged meal kit of FIG. 1.

FIG. 3 illustrates a side perspective view of the protective insert of FIGS. 1 and 2.

FIG. 4 illustrates a side perspective view of the protective insert of FIGS. 1 and 2.

FIG. 5 illustrates a side perspective view of a protective insert, according to an embodiment.

FIG. 6 illustrates a cross-sectional view of a packaged meal kit, according to an embodiment.

FIG. 7 illustrates a perspective exploded view of the packaged meal kit of FIG. 6.

FIG. 8 illustrates a cross-sectional view of a packaged meal kit, according to an embodiment.

FIG. 9 illustrates a perspective exploded view of the packaged meal kit of FIG. 8.

FIG. 10 illustrates a cross-sectional view of a packaged meal kit, according to an embodiment.

FIG. 11 illustrates a perspective exploded view of the packaged meal kit of FIG. 10.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Meal kits are a new and innovative means for preparing meals at home that allow consumers greater variety, flexibility, and efficiency. Fresh ingredients as well as instructions, recipes, and tools for cooking at home can all be provided in a meal kit which can be delivered directly to the consumer's home. A meal kit can simplify cooking since it contains all the ingredients and directions the consumer needs to create a meal. The meal kit can include pre-portioned and pre-measured ingredients, which reduces food waste and provides suitable portions for one or more meals. Additionally, fresh and custom tailored ingredients provide not only healthier and nutritious cooking, but also can account for the recipient's allergies and/or dietary restrictions (e.g., low calorie, low sodium, gluten-free, dairy-free, low carbs, Paleo, Kosher, Halal, etc.). Moreover, meal kit delivery services save time and costs by eliminating the need to travel to a grocery store, and can provide access to rare or certain ingredients not easily found locally.

Cooling and refrigeration techniques are often used for food preservation. In warm climates or during warm seasons, shipping perishable food items can cause spoilage and decay due to environmental conditions (e.g., temperature, humidity, etc.). In particular, when shipping perishable food during the summer proper cooling helps preserve the food until it arrives to the consumer, especially for frozen foods (e.g., proteins). During shipping of frozen food items and non-frozen food items, insulation, cooling, and compartmentalization help preserve products like seafood, meats, vegetables, fruits, and dairy, as well as other foods, and ensure proper delivery to the consumer.

A packaged meal kit with cold preserving packaging ideally maintains colder temperatures around frozen food items relative to non-frozen food items, and protects each from damage and temperature variations during shipping and handling. The herein described packaged meal kit is useful not only as a preservation device for cooling perishable food items in diverse environments (e.g., temperature, humidity, etc.), but it also ensures proper separation and compartmentalization for easy handling and shipping of both frozen and non-frozen pre-portioned food items to be prepared in a meal based on the instructions (e.g., a recipe) included in the meal kit. The described packaged meal kit simplifies and streamlines cooking by including pre-portioned and pre-measured fresh ingredients, both frozen and non-frozen items, and an instruction card with directions and recipes for the consumer to create one or more different meals based on the provided fresh ingredients. Embodiments of the packaged meal kit are described herein.

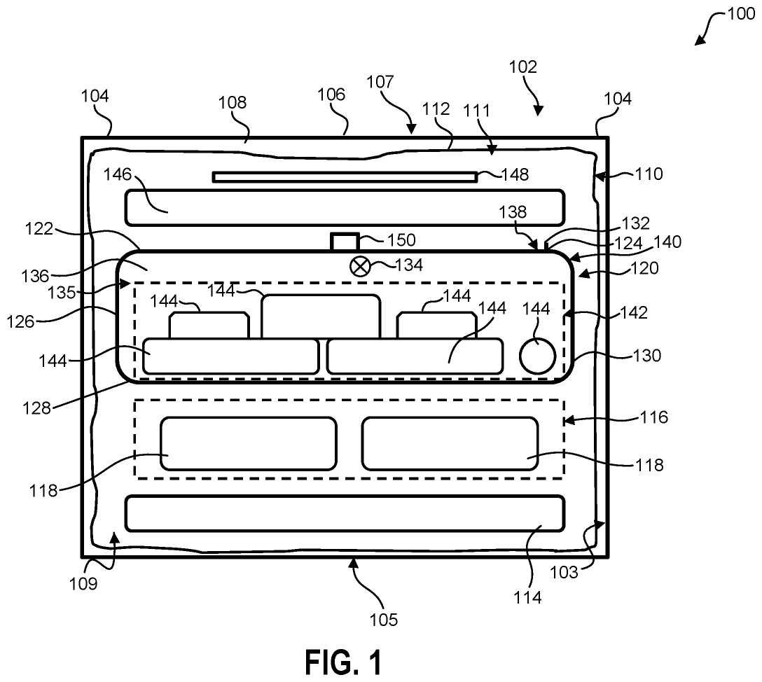

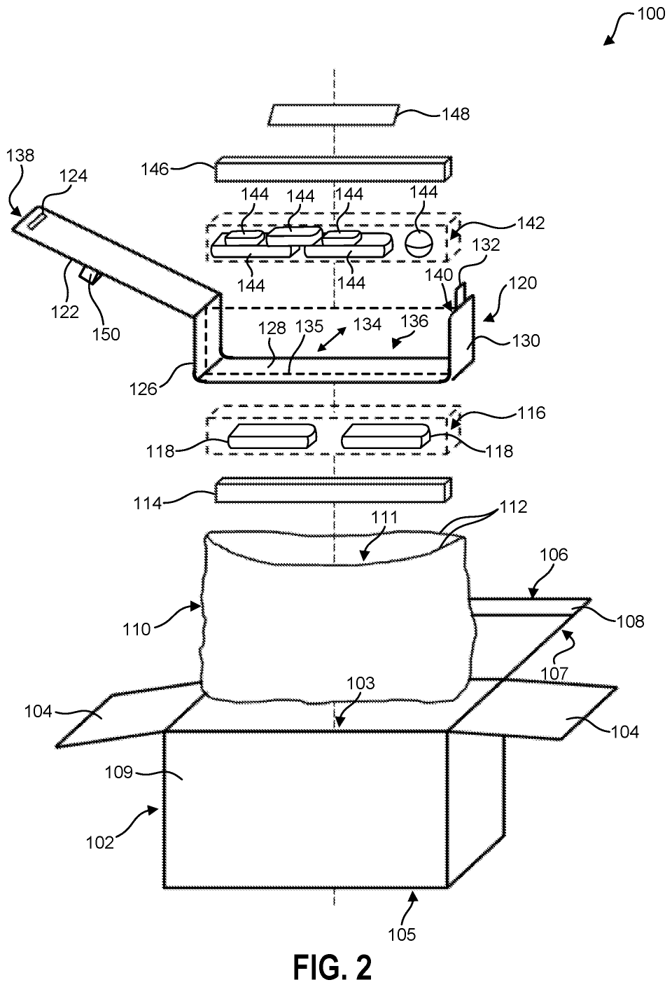

With reference to the drawings and in particular to FIGS. 1 and 2 thereof, packaged meal kit 100 generally comprises container 102, liner 110 disposed adjacent interior 103 of container 102, first cold pack 114 disposed in bottom 105 of container 102 adjacent liner 110, frozen food item section 116 disposed above first cold pack 114, protective insert 120 disposed above frozen food item section 116 and providing hollow cross-section 135 and protective space 136, non-frozen food item section 142 disposed in protective space 136, second cold pack 146 disposed above protective insert 120, and instructions 148 disposed in container 102, each of which is described in more detail below. Protective insert 120 and protective space 136 prevent damage to non-frozen food items 144 placed in non-frozen food item section 116 from first cold pack 114, frozen food items 118, and second cold pack 146.

Referring to FIGS. 1 and 2, container 102 is a three-dimensional (3D) orthotope or box. Container 102 has six sides including height faces, length faces, and depth faces. Top 107 of container 102, opposite bottom 105, includes side flaps 104 and top flap 106. In some embodiments, as shown in FIG. 2, top flap 106 can include top tab 108 to seal and secure side flaps 104 of top 107. In some embodiments, as shown in FIG. 1, container 102 has parallel height faces, parallel length faces, and parallel depth faces. In some embodiments, for example, container 102 is a rigid hollow cuboid. In some embodiments, container 102 can be, for example, a cardboard material or other material providing a rigid structure (e.g., wood, plastic, rubber, polytetrafluoroethylene, polyoxymethylene, phenolics, acetals, nylon, etc.). In some embodiments, container 102 can be a cardboard cuboid. In some embodiments, container 102 can be a rectangular cuboid. For example, container 102 can be a square cuboid.

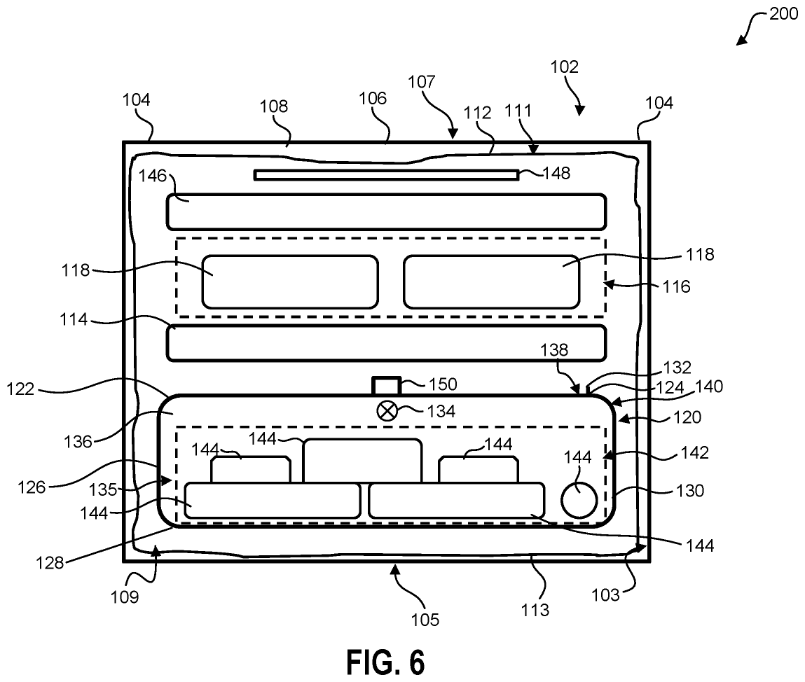

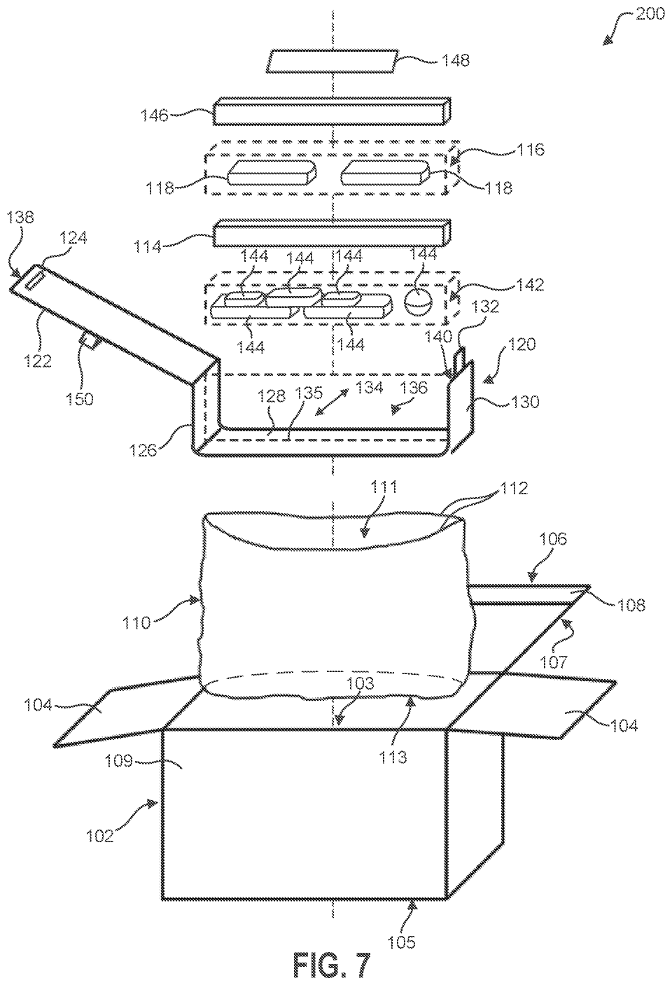

Referring to FIGS. 1 and 2, liner 110 is a thermally insulating lining. In some embodiments, as shown in FIG. 2, liner 110 is a sealable bag with liner seal 112. Liner 110 can have any general shape capable of surrounding and insulating one or more of the items disposed in container 102 (e.g., first cold pack 114, frozen food item section 116, protective insert 120, non-frozen food item section 142, second cold pack 146, instructions 148, etc.). In some embodiments, as shown in FIG. 1, liner 110 is sealed via liner seal 112 to enclose and insulate first cold pack 114, frozen food item section 116, protective insert 120, non-frozen food item section 142, and second cold pack 146. Liner seal 112 can be an adhesive or any other suitable sealant, enclosure, or attachment to close and seal top opening 111 of liner 110. In some embodiments, as shown in FIGS. 6 and 7, alternatively liner 110 can also include bottom opening 113 opposite top opening 111, which can be closed and sealed similar to top opening 111. Liner 110 can be any thermally insulating material. In some embodiments, liner 110 can be, for example, plastic, denim, cotton, sealed air (e.g., bubble wrap), foam, rubber, one or more polymers, polytetrafluoroethylene, polyoxymethylene, phenolics, acetals, nylon, tape, foil, reflective metal (e.g., aluminum, tin, silver, copper, etc.), or any other thermally insulating material.

Referring to FIGS. 1 and 2, first cold pack 114 is a cooling element, packaging, or refrigerant of any general shape. In some embodiments, as shown in FIG. 2, first cold pack 114 is a 3D orthotope or box. In some embodiments, first cold pack 114 is a bag. For example, first cold pack 114 can be a malleable bag. First cold pack 114 is disposed adjacent bottom 105 of container 102. In some embodiments, as shown in FIG. 1, first cold pack 114 is disposed in liner 110. First cold pack 114 can be any cooling element or refrigerant capable of reducing the thermal energy of surrounding or adjacent items (e.g., frozen food item section 116, protective insert 120, non-frozen food item section 142, etc.). In some embodiments, first cold pack 114 can be, for example, ice, sealed ice, dry ice, sealed dry ice, cooling gel, sealed cooling gel, cooling foam, cooling gas, cryogenic, an electronic cooling device (e.g., Peltier cooler, thermoelectric cooler, solid state heat pump, etc.), or any other material, device, or arrangement for cooling or reducing the temperature of the surrounding environment. In some embodiments, first cold pack 114 can be a gel packaging, for example, a drain safe gel, a biodegradable gel, an unsealable gel, and/or any other cooling gel. For example, the gel packaging can be cut or ripped open and then poured down a drain and flow without clogging the drain and biodegrade. For example, the gel packaging can be cut or ripped open and then poured into a compost.

Referring to FIGS. 1 and 2, frozen food item section 116 includes one or more frozen food items 118. In some embodiments, as shown in FIG. 1, frozen food item section 116 is disposed above first cold pack 114 in order to cool and maintain a temperature threshold of frozen food item 118. For example, the temperature threshold of frozen food item 118 is maintained between −80° C. and 0° C. For example, the temperature threshold of frozen food item 118 is ideally maintained between −20° C. and 4° C. In some embodiments, frozen food item 118 is a protein. For example, frozen food item 118 can be a meat or seafood. In some embodiments, frozen food item 118 is seafood, meat, vegetables, fruit, dairy, pasta, noodles, or dough. In some embodiments, as shown in FIGS. 1 and 2, frozen food item 118 is pre-portioned. For example, frozen food item 118 is pre-portioned to prepare a meal based on instructions 148 provided in container 102.

With reference to the drawings and in particular to FIGS. 1-4 thereof, protective insert 120 generally comprises first protective insert section 122, second protective insert section 126, third protective insert section 128, fourth protective insert section 130, first distal end 138, second distal end 140, and handle 150, each of which is described in more detail below.

Referring to FIGS. 1 and 2, protective insert 120 is a 3D hollow orthotope or hollow box. Protective insert 120 has four solid sides including height faces and depth faces, and two hollow or empty length faces. Protective insert 120 is configured to provide or form protective space 136 within an interior (e.g., first protective insert section 122, second protective insert section 126, third protective insert section 128, fourth protective insert section 130) of protective insert 120. Protective insert 120 has hollow cross-section 135 extending along hollow axis 134 parallel to front surface 109 of container 102 in order to provide or form protective space 136. In some embodiments, hollow cross-section 135 can be, for example, elliptical (e.g., circular, oval, etc.), triangular (e.g., equilateral, isosceles, right, askew, obtuse, etc.), polygonal (e.g., rectangular, square, parallelepiped, pentagonal, hexagonal, octagonal, etc.), or any suitable shape to form protective space 136. In some embodiments, first distal end 138 and second distal end 140 can be fastened together to create protective space 136. For example, as shown in FIG. 2, slot 124 of first protective insert section 122 adjacent first distal end 138 is configured to interconnect with tab 132 of fourth protective insert section 130 adjacent second distal end 140. In some embodiments, tab 132 and slot 124 remain fastened and interconnected via an interlocking mechanism, for example, friction, tab 132 is bent or folded toward first protective insert section 122 after being inserted through slot 124, perforated sides of tab 132 allow tab 132 to rotate anti-parallel to slot 124, or a through-hole or slot in tab 132 is configured for an additional tie, cardboard tab, or securing device to be inserted through tab 132 and interlock slot 124 with tab 132. In some embodiments, protective insert 120 can be, for example, a cardboard material or other material providing a rigid structure (e.g., wood, plastic, rubber, polytetrafluoroethylene, polyoxymethylene, phenolics, acetals, nylon, etc.). As shown in FIGS. 1 and 2, protective insert 120 includes handle 150 disposed on first protective insert section 122. In some embodiments, handle 150 can be integral or attached to protective insert 120. For example, handle 150 can be a perforated cardboard handle formed from a transverse (i.e., depth) section of first protective insert section 122. In some embodiments, handle 150 can be, for example, a cardboard material or other material providing a rigid structure (e.g., wood, plastic, rubber, polytetrafluoroethylene, polyoxymethylene, phenolics, acetals, nylon, etc.). In some embodiments, handle 150 can be omitted from protective insert 120. In some embodiments, as shown in FIGS. 1 and 2, protective insert 120 includes rounded or curved corners for easier loading into and removal from liner 110. In some embodiments, protective insert 120 can have square or orthogonal corners. In some embodiments, protective insert 120 can be a cardboard hollow cuboid. In some embodiments, protective insert 120 can be a cardboard rectangular hollow cuboid. For example, protective insert 120 can be a cardboard square hollow cuboid. In some embodiments, as shown in FIG. 2, protective insert 120 is a unitary foldable sleeve. For example, protective insert 120 can be a unitary foldable cardboard sleeve.

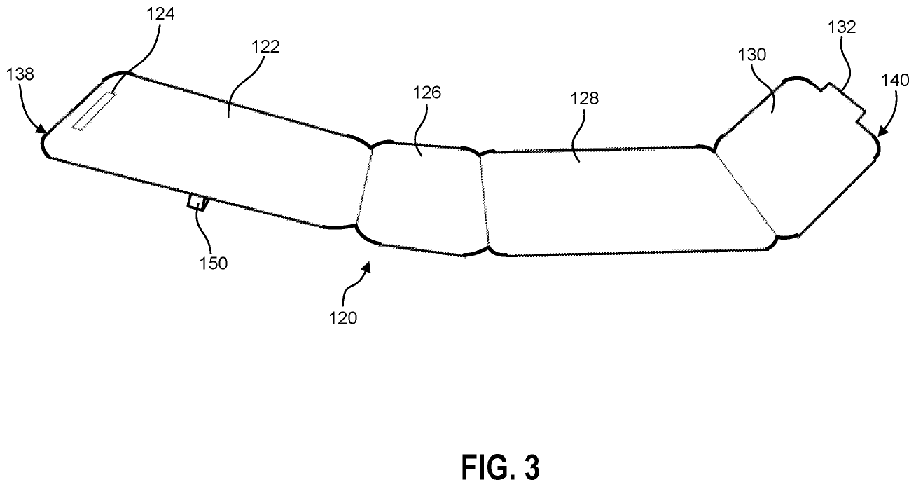

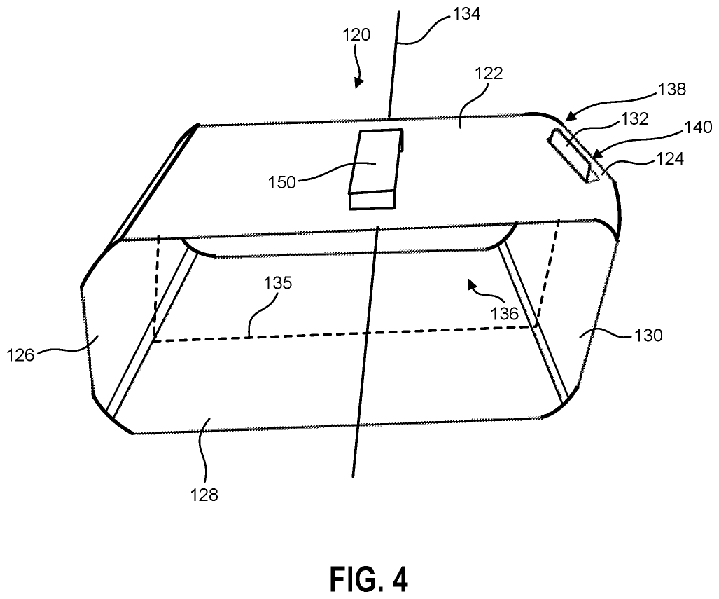

FIGS. 3 and 4 illustrate how protective insert 120 can be constructed to form hollow cross-section 135 and protective space 136. As shown in FIG. 3, protective insert 120 is in an open or disassembled state. As shown in FIG. 4, protective insert is in a closed or assembled state. In some embodiments, as shown in FIGS. 3 and 4, protective insert 120 can be a unitary foldable sleeve. For example, protective insert 120 can be a unitary cardboard foldable sleeve. As described above in reference to FIGS. 1 and 2, protective insert 120 includes first protective insert section 122, second protective insert section 126, third protective insert section 128, fourth protective insert section 130, first distal end 138, and second distal end 140. As shown in FIG. 3, protective insert 120 includes slot 124 and tab 132 located at first distal end 138 and second distal end 140, respectively. In some embodiments, as shown in FIG. 4, first distal end 138 and second distal end 140 can be fastened together to create hollow cross-section 135 and protective space 136. For example, as shown in FIG. 4, tab 132 of fourth protective insert section 130 adjacent second distal end 140 can insert into slot 124 to interconnect first distal end 138 and second distal end 140.

In some embodiments, protective insert 120 can omit either third protective insert section 128 or first protective insert section 122. For example, protective insert 120 can include three solid sides including one height face and two depth faces, two hollow or empty length faces, and one omitted height face. In some embodiments, protective insert 120 can be a C-shaped or U-shaped sleeve. For example, protective insert 120 can be a unitary foldable cardboard sleeve including second protective insert section 126, first protective insert section 122, and fourth protective insert section 130. For example, protective insert 120 can be a unitary foldable cardboard sleeve including second protective insert section 126, third protective insert section 128, and fourth protective insert section 130.

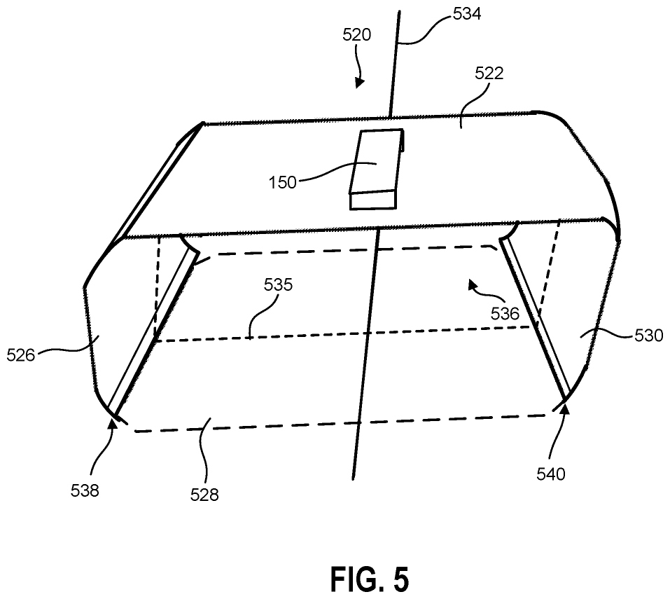

FIG. 5 illustrates an alternative embodiment of protective insert 120. FIG. 5 illustrates protective insert 520, according to embodiments. The embodiments of protective insert 520 shown in FIG. 5 and the embodiments of protective insert 120 shown in FIGS. 1-4 are similar. Similar reference numbers are used to indicate similar features of the embodiments of protective insert 520 shown in FIG. 5 and similar features of the embodiments of protective insert 120 shown in FIGS. 1-4. The main difference between the embodiments of protective insert 520 shown in FIG. 5 and the embodiments of protective insert 120 shown in FIGS. 1-4 is the omission of third protective insert section 128, tab 132 on fourth protective insert section 130, and slot 124 on first protective insert section 122 and first distal end 138 and second distal end 140 are attached or integrally formed to form a unitary foldable sleeve. In some embodiments, packaged meal kit 100 can include protective insert 520 in place of protective insert 120. In some embodiments, packaged meal kits 100, 200, 300, 400 can include protective insert 520 in place of protective insert 120.

Referring to FIG. 5, protective insert 520 is similar to protective insert 120 of FIGS. 1-4. FIG. 5 illustrates protective insert 520, according to an exemplary embodiment. Protective insert 520 includes first protective insert section 526, second protective insert section 522, third protective insert section 530, first distal end 538, and second distal end 540. Protective insert 520 is a 3D hollow orthotope or hollow box without bottom side 528. Protective insert 520 has three solid sides including one height face and two depth faces, two hollow or empty length faces, and one omitted height face. Protective insert 520 is configured to provide or form protective space 536 within an interior (e.g., first protective insert section 526, second protective insert section 522, third protective insert section 530, omitted bottom side 528) of protective insert 520. In some embodiments, first distal end 538 of first protective insert section 526 and second distal end 540 of third protective insert section 530 are disposed above frozen food item section 116 and/or first cold pact 114 of FIGS. 1 and 2. Protective insert 520 has hollow cross-section 535 extending along hollow axis 534 parallel to front surface 109 of container 102 of FIGS. 1 and 2 in order to provide or form protective space 536. In some embodiments, hollow cross-section 535 can be, for example, elliptical (e.g., circular, oval, etc.), triangular (e.g., equilateral, isosceles, right, askew, obtuse, etc.), polygonal (e.g., rectangular, square, parallelepiped, pentagonal, hexagonal, octagonal, etc.), or any suitable shape to form protective space 536. In some embodiments, protective insert 520 can be, for example, a cardboard material or other material providing a rigid structure (e.g., wood, plastic, rubber, polytetrafluoroethylene, polyoxymethylene, phenolics, acetals, nylon, etc.). In some embodiments, protective insert 520 can be a cardboard hollow cuboid without bottom side 528. In some embodiments, protective insert 520 can be a cardboard rectangular hollow cuboid without bottom side 528. For example, protective insert 520 can be a cardboard square hollow cuboid without bottom side 528. In some embodiments, as shown in FIG. 5, protective insert 520 is a unitary foldable sleeve. For example, protective insert 520 can be a unitary C-shaped or U-shaped foldable cardboard sleeve.

Referring to FIGS. 1, 2, and 4, protective space 136 is configured to receive and protect non-frozen food item section 142. Non-frozen food item section 142 includes one or more non-frozen food items 144. In some embodiments, as shown in FIG. 1, non-frozen food item section 142 is disposed in protective space 136 and hollow cross-section 135 of protective insert 120 above first cold pack 114 and frozen food item section 116 to protect and separate frozen food item 118 from non-frozen food item 144. In some embodiments, non-frozen food item 144 is a non-protein (e.g., not seafood or meat). In some embodiments, non-frozen food item 144 is vegetables, fruit, dairy, grains, spices, herbs, nuts, liquids, or other perishable or non-perishable items. In some embodiments, as shown in FIGS. 1 and 2, non-frozen food item 144 is pre-portioned. For example, non-frozen food item 144 is pre-portioned to prepare a meal based on instructions 148 provided in container 102.

Referring to FIGS. 1 and 2, second cold pack 146 is a cooling element, packaging, or refrigerant of any general shape. In some embodiments, as shown in FIG. 2, second cold pack 146 is a 3D orthotope or box. In some embodiments, second cold pack 146 is a bag. For example, second cold pack 146 can be a malleable bag. Second cold pack 146 is disposed above protective insert 120. In some embodiments, as shown in FIG. 1, second cold pack 146 is disposed in liner 110 and disposed above protective insert 120 in order to cool and maintain a temperature threshold of non-frozen food item or items 144. For example, the temperature threshold of non-frozen food item 144 is ideally maintained at a target temperature of approximately between 0° C. to 4° C., but can range between −2° C. to 20° C. depending on ambient conditions. Second cold pack 146 can be any cooling element or refrigerant capable of reducing the thermal energy of surrounding or adjacent items or regions (e.g., non-frozen food item 144, protective insert 120, non-frozen food item section 142, etc.). In some embodiments, second cold pack 146 can be, for example, ice, sealed ice, dry ice, sealed dry ice, cooling gel, sealed cooling gel, cooling foam, cooling gas, cryogenic, an electronic cooling device (e.g., Peltier cooler, thermoelectric cooler, solid state heat pump, etc.), or any other material, device, or arrangement for cooling or reducing the temperature of the surrounding environment. In some embodiments, second cold pack 146 can be a gel packaging, for example, a drain safe gel, a biodegradable gel, an unsealable gel, and/or any other cooling gel. For example, the gel packaging can be cut or ripped open and then poured down a drain and flow without clogging the drain and biodegrade. For example, the gel packaging can be cut or ripped open and then poured into a compost.

Referring to FIGS. 1 and 2, instructions 148 are disposed in container 102. Instructions 148 are provided on a card and are for preparing one or more different meals from one or more items (e.g., frozen food item 118, non-frozen food item 144) in container 102. In some embodiments, as shown in FIG. 1, instructions 148 can be disposed inside liner 110. In some embodiments, instructions 148 can be disposed outside and atop liner 110. In some embodiments, instructions 148 can be provided on protective insert 120. For example, instructions 148 can be printed on first protective insert section 122 of protective insert 120. In some embodiments, instructions 148 are for preparing a meal from pre-portioned frozen food item 118 and pre-portioned non-frozen food item 144 based on instructions 148. In some embodiments, instructions 148 are directions, recipes, and/or tools for cooking one or more different meals from packaged meal kit 100. In some embodiments, instructions 148 are one or more directions, recipes, and/or tools for preparing pre-portioned and pre-measured frozen food item 118 and pre-portioned and pre-measured non-frozen food item 144 provided in packaged meal kit 100. For example, instructions 148 can provide recipes for a recipient's allergies, dietary restrictions (e.g., low calorie, low sodium, gluten-free, dairy-free, low carbs, Paleo, Kosher, Halal, etc.), and/or preferences (e.g., seasonal, regional, cultural, popular, etc.).

In some embodiments, packaged meal kit 100 can include one or more additional cold packs. For example, one or more additional cold packs, similar to first cold pack 114 and second cold pack 146, can be disposed vertically in liner 110 along interior 103 (e.g., sidewalls) of container 102. For example, an additional cold pack, similar to first cold pack 114 and second cold pack 146, can be disposed above frozen food item section 116 and below protective insert 120. In some embodiments, packaged meal kit 100 can include one or more additional liners. For example, liner 110 can enclose first cold pack 114 and frozen food item section 116, while an additional liner, similar to liner 110, can enclose second cold pack 146, protective insert 120, and non-frozen food item section 142. In some embodiments, packaged meal kit 100 can include one or more protective inserts. For example, protective insert 120 can enclose non-frozen food item section 142, while an additional protective insert, similar to protective insert 120, can enclose frozen food item section 116 or an additional non-frozen food item section, similar to non-frozen food item section 142. In some embodiments, packaged meal kit 100 can include a different vertical arrangement of first cold pack 114, frozen food item section 116, protective insert 120, non-frozen food item section 142, second cold pack 146, and/or instructions 148.

With reference to the drawings and in particular to FIGS. 6 and 7 thereof, packaged meal kit 200 generally comprises container 102, liner 110 disposed adjacent interior 103 of container 102, protective insert 120 disposed in bottom 105 of container 102 adjacent liner 110 and providing protective space 136, non-frozen food item section 142 disposed in protective space 136, first cold pack 114 disposed above protective insert 120, frozen food item section 116 disposed above first cold pack 114, second cold pack 146 disposed above frozen food item section 116, and instructions 148 disposed in container 102. In some embodiments, liner 110 can include bottom opening 113 opposite top opening 111, which can be closed and sealed similar to top opening 111. For example, packaged meal kit 200 can be assembled in a similar fashion to packaged meal kit 100, for example, on an assembly line, via bottom opening 113 and sealed top opening 111, which allows packaged meal kit 200 to be inverted after assembly.

FIGS. 6 and 7 illustrate alternative embodiments of packaged meal kit 100. The embodiments of packaged meal kit 200 shown in FIGS. 6 and 7 and the embodiments of packaged meal kit 100 shown in FIGS. 1 and 2 are similar. Similar reference numbers are used to indicate similar features of the embodiments of packaged meal kit 200 shown in FIGS. 6 and 7 and similar features of the embodiments of packaged meal kit 100 shown in FIGS. 1 and 2. The main difference between the embodiments of packaged meal kit 200 shown in FIGS. 6 and 7 and the embodiments of packaged meal kit 100 shown in FIGS. 1 and 2 is the rearrangement of the elements such that protective insert 120 with non-frozen food item section 142 is below frozen food item section 116 and first cold pack 114. Packaged meal kit 200 provides better cooling of frozen food item section 116 by surrounding frozen food items 118 with first cold pack 114 below and second cold pack 146 above frozen food item section 116

In some embodiments, packaged meal kit 200 can include one or more additional cold packs. For example, one or more additional cold packs, similar to first cold pack 114 and second cold pack 146, can be disposed vertically in liner 110 along interior 103 (e.g., sidewalls) of container 102. In some embodiments, packaged meal kit 200 can include one or more additional liners. For example, liner 110 can enclose protective insert 120 and non-frozen food item section 142, while an additional liner, similar to liner 110, can enclose first cold pack 114, frozen food item section 116, and second cold pack 146. In some embodiments, packaged meal kit 200 can include one or more protective inserts. For example, protective insert 120 can enclose non-frozen food item section 142, while an additional protective insert, similar to protective insert 120, can enclose frozen food item section 116 or an additional non-frozen food item section, similar to non-frozen food item section 142. In some embodiments, packaged meal kit 200 can include a different vertical arrangement of first cold pack 114, protective insert 120, non-frozen food item section 142, second cold pack 146, frozen food item section 116, and/or instructions 148. In some embodiments, liner 110 is a sealable thermally insulating liner with sealable top opening 111 and sealable bottom opening 113 opposite the top opening 111.

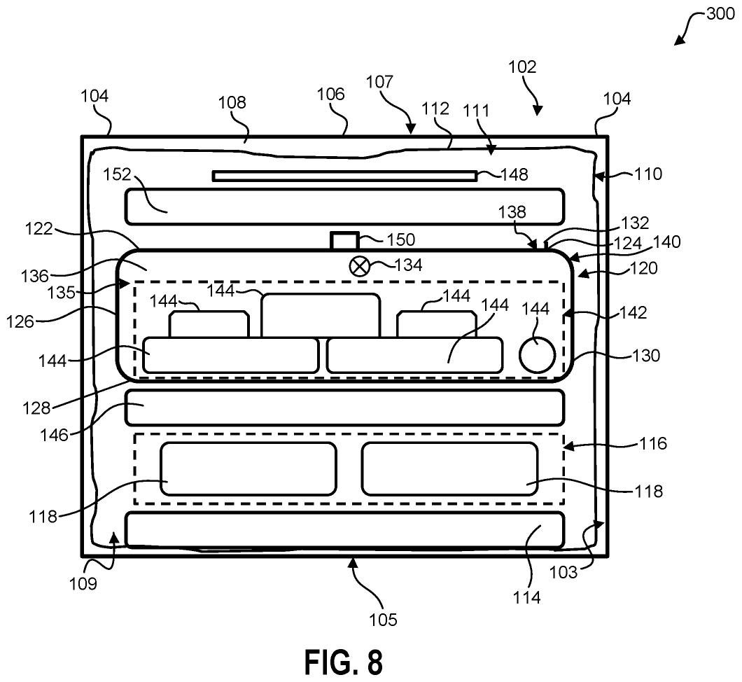

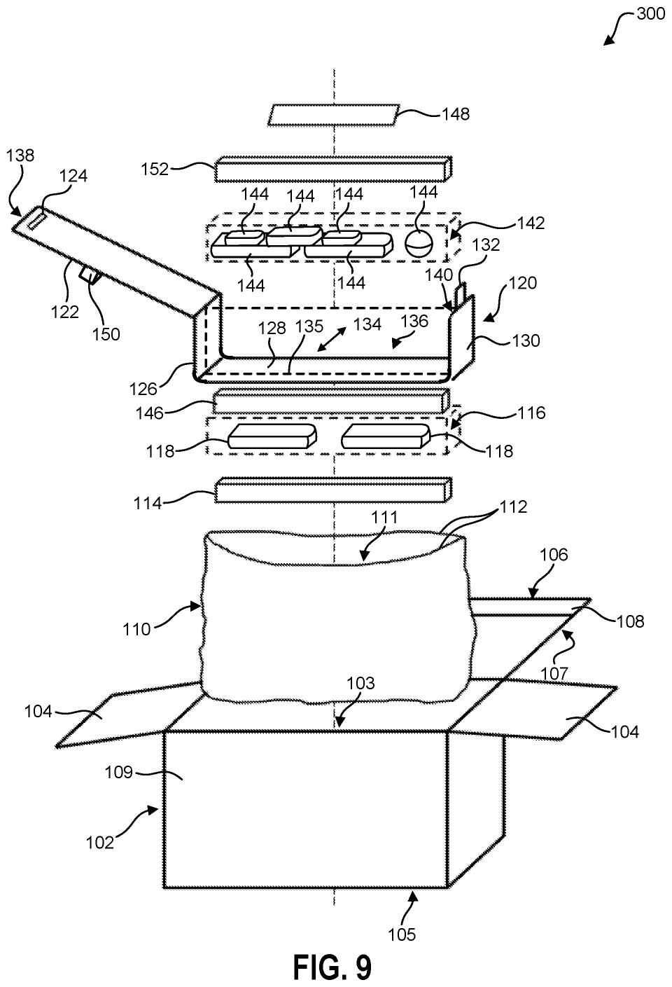

With reference to the drawings and in particular to FIGS. 8 and 9 thereof, packaged meal kit 300 generally comprises container 102, liner 110 disposed adjacent interior 103 of container 102, first cold pack 114 disposed in bottom 105 of container 102 adjacent liner 110, frozen food item section 116 disposed above first cold pack 114, second cold pack 146 disposed above frozen food item section 116 and below protective insert 120, protective insert 120 disposed above frozen food item section 116 and second cold pack 146 and providing hollow cross-section 135 and protective space 136, non-frozen food item section 142 disposed in protective space 136, third cold pack 152 disposed above protective insert 120, and instructions 148 disposed in container 102. Protective insert 120 and protective space 136 prevent damage to non-frozen food items 144 placed in non-frozen food item section 116 from first cold pack 114, frozen food items 118, second cold pack 146, and third cold pack 152.

Referring to FIGS. 8 and 9, third cold pack 152 is a cooling element, packaging, or refrigerant of any general shape. In some embodiments, as shown in FIG. 9, third cold pack 152 is a 3D orthotope or box. In some embodiments, third cold pack 152 is a bag. For example, third cold pack 152 can be a malleable bag. Third cold pack 152 is disposed above protective insert 120. In some embodiments, as shown in FIG. 8, third cold pack 152 is disposed in liner 110 and disposed above protective insert 120 in order to cool and maintain a temperature threshold of non-frozen food item 144. For example, the temperature threshold of non-frozen food item 144 is ideally maintained at a target temperature of approximately between 0° C. to 4° C., but can range between −2° C. to 20° C. depending on ambient conditions. Third cold pack 152 can be any cooling element or refrigerant capable of reducing the thermal energy of surrounding or adjacent items (e.g., frozen food item section 116, protective insert 120, non-frozen food item section 142, etc.). In some embodiments, third cold pack 152 can be, for example, ice, sealed ice, dry ice, sealed dry ice, cooling gel, sealed cooling gel, cooling foam, cooling gas, cryogenic, an electronic cooling device (e.g., Peltier cooler, thermoelectric cooler, solid state heat pump, etc.), or any other material, device, or arrangement for cooling or reducing the temperature of the surrounding environment. In some embodiments, third cold pack 152 can be a gel packaging, for example, a drain safe gel, a biodegradable gel, an unsealable gel, and/or any other cooling gel. For example, the gel packaging can be cut or ripped open and then poured down a drain and flow without clogging the drain and biodegrade. For example, the gel packaging can be cut or ripped open and then poured into a compost.

FIGS. 8 and 9 illustrate alternative embodiments of packaged meal kit 100. The embodiments of packaged meal kit 300 shown in FIGS. 8 and 9 and the embodiments of packaged meal kit 100 shown in FIGS. 1 and 2 are similar. Similar reference numbers are used to indicate similar features of the embodiments of packaged meal kit 300 shown in FIGS. 8 and 9 and similar features of the embodiments of packaged meal kit 100 shown in FIGS. 1 and 2. The main difference between the embodiments of packaged meal kit 300 shown in FIGS. 8 and 9 and the embodiments of packaged meal kit 100 shown in FIGS. 1 and 2 is the addition of third cold pack 152 and rearrangement of second cold pack 146 between protective insert 120 and frozen food item section 116. Packaged meal kit 300 provides better cooling of frozen food item section 116 by surrounding frozen food items 118 with first cold pack 114 below and second cold pack 146 above frozen food item section 116, and improves cooling of non-frozen food item section 142 with third cold pack 152. In some embodiments, packaged meal kit 300 can be used for summer months or for long or extended (e.g., 2-day) shipping, and provide additional cooling via first cold pack 114, second cold pack 146, and third cold pack 152.

In some embodiments, packaged meal kit 300 can include one or more additional cold packs. For example, one or more additional cold packs, similar to first cold pack 114, second cold pack 146, and third cold pack 152, can be disposed vertically in liner 110 along interior 103 (e.g., sidewalls) of container 102. In some embodiments, packaged meal kit 300 can include one or more additional liners. For example, liner 110 can enclose protective insert 120, non-frozen food item section 142, and third cold pack 152, while an additional liner, similar to liner 110, can enclose first cold pack 114, frozen food item section 116, and second cold pack 146. In some embodiments, packaged meal kit 300 can include one or more protective inserts. For example, protective insert 120 can enclose non-frozen food item section 142, while an additional protective insert, similar to protective insert 120, can enclose frozen food item section 116 or an additional non-frozen food item section, similar to non-frozen food item section 142. In some embodiments, packaged meal kit 300 can include a different vertical arrangement of first cold pack 114, protective insert 120, non-frozen food item section 142, second cold pack 146, frozen food item section 116, third cold pack 152, and/or instructions 148.

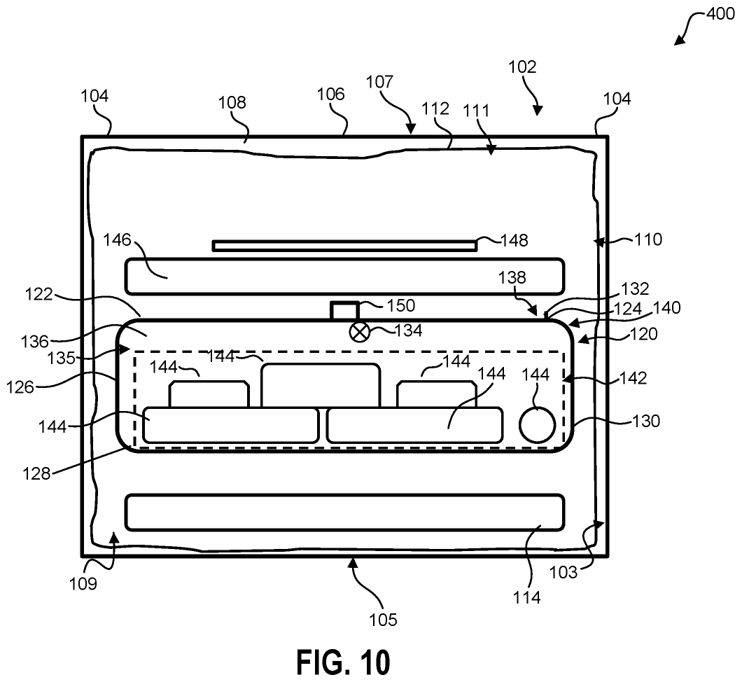

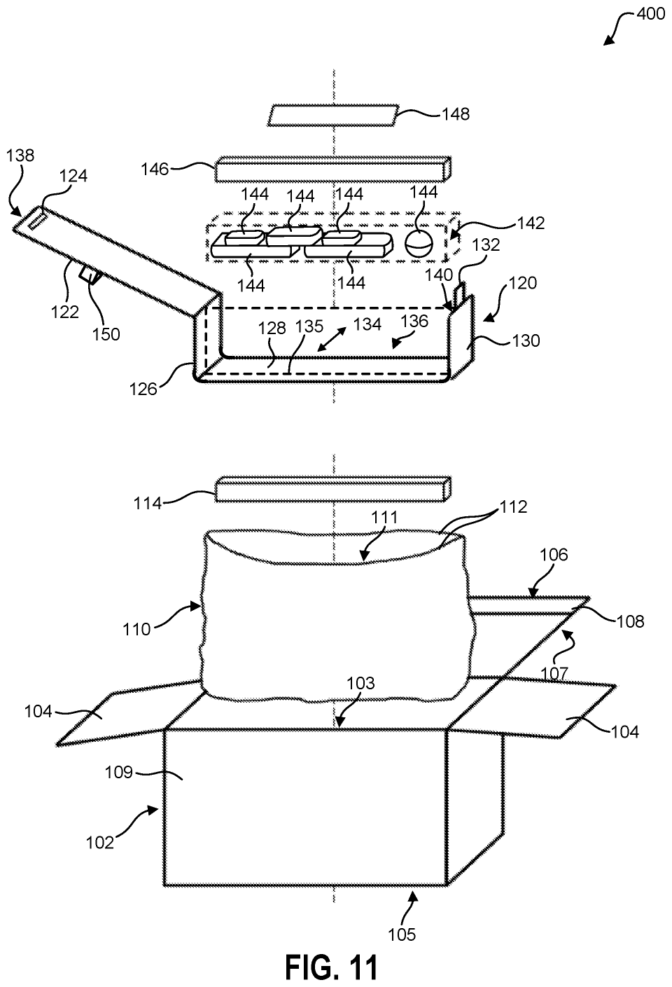

With reference to the drawings and in particular to FIGS. 10 and 11 thereof, packaged meal kit 400 generally comprises container 102, liner 110 disposed adjacent interior 103 of container 102, first cold pack 114 disposed in bottom 105 of container 102 adjacent liner 110, protective insert 120 disposed above first cold pack 114 and providing hollow cross-section 135 and protective space 136, non-frozen food item section 142 disposed in protective space 136, second cold pack 146 disposed above protective insert 120, and instructions 148 disposed in container 102. Protective insert 120 and protective space 136 prevent damage to non-frozen food items 144 placed in non-frozen food item section 142 from first cold pack 114 and second cold pack 146.

FIGS. 10 and 11 illustrate alternative embodiments of packaged meal kit 100. The embodiments of packaged meal kit 400 shown in FIGS. 10 and 11 and the embodiments of packaged meal kit 100 shown in FIGS. 1 and 2 are similar. Similar reference numbers are used to indicate similar features of the embodiments of packaged meal kit 400 shown in FIGS. 10 and 11 and similar features of the embodiments of packaged meal kit 100 shown in FIGS. 1 and 2. The main difference between the embodiments of packaged meal kit 400 shown in FIGS. 10 and 11 and the embodiments of packaged meal kit 100 shown in FIGS. 1 and 2 is the omission of frozen food item section 116. Packaged meal kit 400 provides a vegetarian or non-protein (i.e., no meat or seafood) option, while still cooling non-frozen food item section 142 by surrounding protective insert 120 with non-frozen food items 144 with first cold pack 114 below and second cold pack 146 above non-frozen food item section 142.

In some embodiments, packaged meal kit 400 can include one or more additional cold packs. For example, one or more additional cold packs, similar to first cold pack 114 and second cold pack 146, can be disposed vertically in liner 110 along interior 103 (e.g., sidewalls) of container 102. In some embodiments, packaged meal kit 400 can include one or more protective inserts. For example, protective insert 120 can enclose non-frozen food item section 142, while an additional protective insert, similar to protective insert 120, can enclose an additional non-frozen food item section, similar to non-frozen food item section 142. In some embodiments, packaged meal kit 400 can include a different vertical arrangement of first cold pack 114, protective insert 120, non-frozen food item section 142, second cold pack 146, and/or instructions 148. In some embodiments, the non-frozen food items 144 are not a meat or seafood.

In use, a consumer receives packaged meal kit 100. The consumer opens top flap 106 and then side flaps 104 of container 102. The consumer removes instructions 148 disposed above liner 110 and below top flap 106. After removing instructions 148, the consumer opens liner seal 112 of liner 110 to expose top opening 111. The consumer removes second cold pack 146 from liner 110 and container 102 to reveal protective insert 120. The consumer then removes protective insert 120 with non-frozen food items 144 from liner 110 and container 102 and places protective insert 120 and non-frozen food items 144 stored therein in a refrigerator. Alternatively, the consumer may remove the non-frozen food items 144 from protective insert 120 and place the non-frozen food items 144 in a refrigerator and dispose of protective insert 120. The consumer then removes frozen food items 118 from liner 110 and container 102.

When the consumer is ready to make a meal from the ingredients in the meal kit, the consumer follows instructions 148 to prepare one or more meals. For example, the consumer uses instructions 148 to prepare one or more different meals from one or more pre-portioned items (e.g., frozen food item 118, non-frozen food item 144) in container 102. For example, the consumer uses instructions 148 for directions, recipes, and/or tools for cooking one or more different meals from packaged meal kit 100. Packaged meal kits 200, 300, 400 are used in a similar fashion to packaged meal kit 100 as described above.

It is to be appreciated that the Detailed Description section, and not the Brief Summary and Abstract sections, is intended to be used to interpret the claims. The Summary and Abstract sections may set forth one or more but not all exemplary embodiments of the handheld spinner as contemplated by the inventor, and thus, are not intended to limit the present embodiments and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A packaged meal kit comprising:
a container;
a liner disposed adjacent an interior of the container;
a first cold pack disposed in a bottom of the container adjacent the liner;
a frozen food item disposed above the first cold pack;
a rigid protective insert, wherein the rigid protective insert comprises a hollow cross-section disposed above the frozen food item;
a non-frozen food item loosely disposed in the hollow cross-section;
a second cold pack disposed above the rigid protective insert; and
instructions disposed in the container for preparing a meal including the frozen food item and the non-frozen food item,
wherein the frozen food item and the non-frozen food item are pre-portioned,
wherein the liner is a sealable thermally insulating liner which encloses the first cold pack, the frozen food item, the rigid protective insert, the non-frozen food item, and the second cold pack, and
wherein the rigid protective insert avoids damage to the non-frozen food item.

2. The packaged meal kit of claim 1, wherein the container is a cardboard cuboid.

3. The packaged meal kit of claim 1, wherein the frozen food item is a meat or seafood.

4. The packaged meal kit of claim 1, wherein the non-frozen food item is not a meat or seafood.

5. The packaged meal kit of claim 1, wherein the rigid protective insert is a unitary foldable cardboard sleeve.

6. The packaged meal kit of claim 5, wherein a first distal end and a second distal end of the unitary foldable cardboard sleeve are fastened together to create the hollow cross-section.

7. The packaged meal kit of claim 6, wherein the first and second distal ends are fastened by a tab and a slot.

8. The packaged meal kit of claim 1, wherein the frozen and non-frozen food items are pre-portioned to correspond to portions identified on the instructions.

9. The packaged meal kit of claim 1, wherein the instructions are:
provided on a card; or
provided on the rigid protective insert.

10. The packaged meal kit of claim 1, wherein the rigid protective insert includes a handle.

11. The packaged meal kit of claim 1, further comprising a third cold pack disposed above the frozen food item and below the rigid protective insert.

12. A packaged meal kit comprising:
a container;
a cold pack disposed in a bottom of the container;
a frozen food item disposed above the cold pack;
a rigid protective insert, wherein the rigid protective insert comprises a hollow cross-section disposed above the frozen food item;
a non-frozen food item loosely disposed in the hollow cross-section;
a second cold pack disposed above the rigid protective insert; and
instructions disposed in the container for preparing a meal including the frozen food item and the non-frozen food item.

13. The packaged meal kit of claim 12, further comprising a thermally insulating liner disposed adjacent an interior of the container.

14. The packaged meal kit of claim 12, wherein the frozen food item is a meat or seafood.

15. The packaged meal kit of claim 12, wherein the rigid protective insert is a unitary foldable cardboard sleeve.

16. The packaged meal kit of claim 12, wherein the rigid protective insert comprises a bottom surface.

17. The packaged meal kit of claim 12, wherein the rigid protective insert comprises rounded corners.

18. The packaged meal kit of claim 12, wherein the instructions are:
provided on a card; or
provided on the rigid protective insert.

19. A packaged meal kit comprising:
a container;
a rigid protective insert disposed in a bottom of the container, wherein the rigid protective insert comprises a hollow cross-section;
a non-frozen food item loosely disposed in the hollow cross-section;
a first cold pack disposed above the rigid protective insert;
a frozen food item disposed above the first cold pack;
a second cold pack disposed above the frozen food item; and
instructions disposed in the container for preparing a meal including the frozen food item and the non-frozen food item, and
wherein the frozen food item and the non-frozen food item are pre-portioned.

20. The packaged meal kit of claim 1, wherein the liner is a sealable thermally insulating liner with a first opening and a second opening opposite the first opening.

21. A packaged meal kit comprising:
a container;
a first cold pack disposed in a bottom of the container;
a rigid protective insert, wherein the rigid protective insert comprises a hollow cross-section disposed above the first cold pack;
a non-frozen food item loosely disposed in the hollow-cross section;
a second cold pack disposed above the rigid protective insert; and
instructions disposed in the container for preparing a meal including the non-frozen food item,
wherein the non-frozen food item is pre-portioned, and
wherein the rigid protective insert avoids damage to the non-frozen food item.

22. The packaged meal kit of claim 21, wherein the non-frozen food item is not a meat or seafood.
